(19) United States
(12) Patent Application Publication
(10) Pub. No.: US 2013/0056021 A1
(43) Pub. Date: Mar. 7, 2013

(54) ANTIFOULING DEVICE FOR DUCTS

(71) Applicant: Armando MARZORATI, Santo Stefano Ticino (MI) (IT)

(72) Inventor: Armando MARZORATI, Santo Stefano Ticino (MI) (IT)

(73) Assignee: LAIN ELECTRONIC S.R.L., Corbetta (MI) (IT)

(21) Appl. No.: 13/587,221

(22) Filed: Aug. 16, 2012

(30) Foreign Application Priority Data
Sep. 7, 2011 (EP) EP11180453

(51) Int. Cl. B08B 9/032

(52) U.S. Cl. 134/1; 134/169 C

(57) ABSTRACT

An antifouling device (1) adapted to be fastened to a duct (10) including a fluid and to be connected to a generator apparatus (20) for generation of an alternating electrical signal; the antifouling device (1) comprises at least one piezoelectric unit (2) adapted to convert the alternating electrical signal into mechanical vibrations, and a diffuser (3) adapted to be interposed between the duct (10) and the piezoelectric unit (2) so as to transmit the mechanical vibrations from the piezoelectric unit (2) to the duct (10) and create cavitation of at least part of the fluid.

### RELATED APPLICATIONS

This non-provisional patent application claims foreign priority based on European Patent Office application EP11180453.0 filed on Sep. 7, 2011.

### FIELD OF THE INVENTION

The present invention relates to an antifouling device for ducts of the type adapted to be fastened to a duct including a fluid, and to be connected to a generator apparatus for generation of an alternating electrical signal.

In particular, the invention relates to a device capable of removing vegetable formations and therefore eliminating algae and other vegetable deposits from a pipe or other similar means used for conveying a fluid such as water, for example.

More specifically, the invention relates to a particular device to be used for removal of algae or other similar deposits from the ducts of the seawater circuits that are present in ships, platforms or other types of water-craft.

### DESCRIPTION OF THE PRIOR ART

It is known that one of the most important plants in a water-craft is the seawater circuit that is used both for cooling the main and auxiliary engines and for cleaning the sanitary fixtures. In addition, in order to reduce consumption of fresh water and extend the water-craft's autonomy, the seawater circuit, through treatment of the seawater, can provided water for showers, dish and garment washing and water-craft cleaning.

The seawater has a high concentration of vegetable micro/macro organisms (algae) tending to settle on the inner surface of the ducts thus creating formation of vegetable deposits thereon. In addition, the seawater is characterised by high content of dissolved salts (included between 35 g/L and 40 g/L) that, in turn tend to deposit on the inner surface of the duct thus creating non vegetable residues.

Deposit of the aforesaid residues on the inner surface of the ducts produces high decay of the seawater circuits because, by causing trouble to the fluid flow, said deposits create problems to the circuit operation and in some cases reduce the circuit lifetime damaging the ducts themselves.

In particular, one of the most important problems of the seawater circuit is represented by the quick formation of fouling and, above all, deposits of algae (biofouling) tending to reduce the efficiency of such plants.

Another problem resides in the frequency and complexity of the maintenance operations and, in particular, the difficulty in removing encrustation, algae or other deposits from the ducts of these circuits.

To solve these problems and therefore remove algae from the seawater circuit ducts, one of the most used techniques contemplates removal of a surface layer.

In particular, in this method the following operations are for example provided: stopping of the seawater circuit, dismantling of the ducts and then cleaning of the ducts themselves through removal of a thin surface layer from the inner surface.

This technique has important drawbacks due to its complexity and the long time required for carrying out cleaning of the whole plant.

To speed up this procedure, other cleaning techniques have been conceived.

In particular, one of them contemplates use of a plant inhibiting formation of fouling in a seawater circuit through emission of copper ions obtained from anodes to which current to low intensity is applied.

In another technique partial electrolysis of the sodium chloride (NaCl) contained in the seawater is provided, through low voltage application between two electrodes suitably disposed in appropriate pipes external to the seawater circuit.

In particular, through said electrodes, formation of a diluted solution of active sodium is caused, in the form of sodium hypochlorite (NaOCl) that, introduced into the water circuit, has the effect of an antifouling treatment and therefore destroys the organic substances present in the seawater.

In a further technique use of suitable chlorine-containing tanks is provided, which tanks are brought into connection for fluid passage with the seawater circuit and release a chlorine amount necessary for eliminating algae into the ducts.

The above mentioned known techniques have some important drawbacks.

A first problem is represented by the high costs for putting the aforesaid techniques into practice and in particular the high costs for producing the necessary plants for accomplishment of these techniques.

Another problem resides in particular in the great bulkiness of the machines and containers required for the known art techniques.

In addition, it should be pointed out that the problem related to bulkiness is particularly important in water-crafts where an element of primary importance has always been optimisation of volumes and bulkiness.

An important defect belonging above all to the last-mentioned techniques is represented by the fact that high polluting substances, such as chlorine are released to the external environment and therefore into the sea.

A further problem resides in that known techniques do not ensure a high cleaning quality. In fact, these techniques are very effective only with vegetable organisms dissolved in the fluid, while they are particularly ineffective on vegetable deposits that are formed on the inner surface of the ducts.

Another fault of the aforesaid techniques is that they must be carried out almost continuously for ensuring good results and therefore there is a great waste of energy.

Another important problem, above all typical of the two last-mentioned techniques is represented by the fact that they give rise to dispersion of polluting substances into the sea. In particular, when these techniques are carried out, high amounts of chlorine are released into the sea, which thing will be forbidden by law starting from 2012.

### SUMMARY OF THE INVENTION

Under this situation, the technical task underlying the present invention is to conceive an antifouling device for ducts capable of substantially obviating the mentioned drawbacks.

Within the scope of this technical task it is an important aim of the invention to conceive an antifouling device that is able to carry out high-quality cleaning of the duct.

Another important aim of the invention is to provide an antifouling device of simple and cheap construction and easy use.

A still further aim of the invention is to create a device capable of carrying out the cleaning operation without use of chlorine or other polluting substances.

The technical task mentioned and the aims specified are achieved by an antifouling device adapted to be fastened to a duct including a fluid, and to be connected to a generator apparatus for generation of an alternating electrical signal. The antifouling device comprises at least one piezoelectric unit adapted to convert the alternating electrical signal into mechanical vibrations, and a diffuser adapted to be interposed between the duct and the at least one piezoelectric unit so as to transmit the mechanical vibrations from the piezoelectric unit to said duct and create cavitation of at least part of the fluid.

### BRIEF DESCRIPTION OF THE DRAWINGS

The features and advantages of the invention are hereinafter clarified by the detailed description of a preferred embodiment of the invention, with reference to the accompanying drawings, in which:

FIG. 1 shows a scale section of the antifouling device according to the invention;

FIG. 2 shows an apparatus for use of the antifouling device; and

FIG. 3 illustrates an application of the antifouling device according to the invention.

### DESCRIPTION OF THE PREFERRED EMBODIMENTS

With reference to the drawings, the antifouling device according to the invention has been generally denoted at 1.

In particular, the invention relates to a particular device to be used for removing at least vegetable deposits tending to accumulate in a duct 10, a pipe or other similar element adapted to convey and move a fluid inside it. In particular, the antifouling device 1 is suitable for use in ducts 10 of seawater circuits for removing at least the alga layer created on the inner surface 10a of duct 10. More specifically, device 1 is adapted to eliminate not only vegetable deposits but also non-vegetable deposits i.e. scaling due to the presence of salt and other substances that are dissolved in the seawater and tend to accumulate on the inner surface 10a of the ducts 10 of a seawater circuit.

To this aim, the antifouling device 1 is adapted to induce a cavitation phenomenon inside duct 10 and, more specifically, in at least part of the fluid conveyed by said duct through application of vibrations taking place inside duct 10. In particular, device 1 is adapted to induce cavitation of at least part of the fluid through vibrations having frequencies for cavitation substantially included between 10 kHz and 50 kHz, preferably substantially included between 20 kHz and 35 kHz and more preferably substantially equal to 22 kHz.

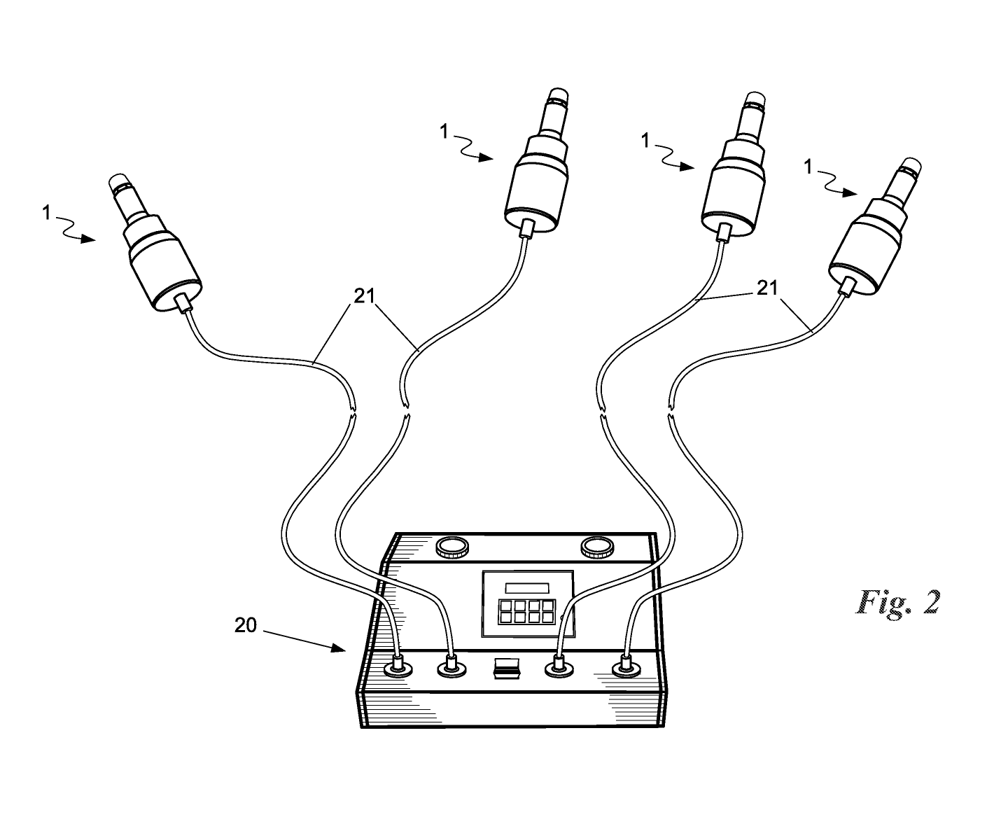

Device 1 can be used for providing a cleaning apparatus 100 (FIG. 2) to be used on ducts 10 of seawater circuits.

Said cleaning apparatus 100 comprises, in addition to one or more antifouling devices 1, a generator 20 that, through suitable electric connections 21, is adapted to send a suitable alternating electrical signal to each of devices 1 of apparatus 100, said signal having a frequency substantially equal to the aforesaid frequencies for cavitation.

Generator 20 therefore comprises an electric source that may consist of a battery, a connection to an outer electricity supply network, and control members 22, switches and/or knobs for example, enabling the electric frequency to be adjusted and the antifouling devices 1, and as a result the cleaning apparatus 100, to be activated, deactivated and operated.

An example of such a generator 20 is for example described in the publication of application EP-A-1844750, between paragraph [0048] and paragraph [0059], and illustrated in the related figures.

Taking into account the fact that device 1 converts the alternating electrical signal from generator 20 into mechanical vibrations having the same frequencies and that for inducing said cavitation with reduced energy consumption it must vibrate according to the resonance frequencies (which frequencies enable mechanical vibrations of almost maximum amplitude to be obtained), said device 1 is made in such a manner that its resonance frequencies are at frequencies necessary for cavitation of at least part of the fluid.

Therefore the antifouling device 1 is made in such a manner that it has resonance at frequencies substantially included between 10 kHz and 50 kHz, preferably substantially included between 20 kHz and 35 kHz and more preferably substantially equal to 22 kHz.

The antifouling device 1 comprises at least one, preferably two, piezoelectric units 2, said units being adapted to convert said alternating electrical signal into mechanical vibrations; a diffuser 3 adapted to be interposed between duct 10 and the piezoelectric unit 2 so as to transmit the mechanical vibrations produced by unit 2 to duct 10; a block 4 adapted to be brought into contact with said unit 2 on the opposite side relative to diffuser 3; and a casing 5 suitable for engagement with diffuser 3 so as to define a housing chamber 5a for the piezoelectric units and block 4.

Each piezoelectric unit 2 comprises a piezoelectric body 2a suitable to convert the electrical signal emitted by generator 20 into mechanical vibrations, and a conductive body 2b adapted to be brought into electric connection with the generator apparatus 20 through electric connections 21. In particular, the two bodies are substantially adjacent to each other so as to enable the electrical signal to pass from the conductive body 2b to the piezoelectric body 2a.

The piezoelectric body 2a is made of piezoelectric ceramic material preferably consisting of an intermetallic lead and titanium compound, commonly referred to as “lead-titanate”.

The piezoelectric body 2a has a cylindrical/disc-shaped form with an outer diameter and thickness substantially included between 20 mm and 50 mm and 2 mm and 15 mm respectively, preferably substantially included between 30 mm and 40 mm and 4 mm and 10 mm respectively, and more preferably substantially equal to 38 mm and 5 mm, respectively.

The conductive body 2b substantially in the same manner as the piezoelectric body 2a, substantially has a cylindrical/disc-shaped form, and is made of a copper alloy or an alloy of other conductive metals. Said conductive body 2b preferably has the same diameter as, or similar diameter to that of the piezoelectric body 2a and height substantially lower than 4 mm.

In order to always keep both bodies 2b and 2a and the two or more units 2 in contact with each other, the antifouling device 1 comprises clamping means 6 adapted to sandwich the different elements of device 1 and, in detail, to press block 4 and diffuser 3 against each other fastening the piezoelectric unit 2 between said two components and consequently the various bodies 2b and 2a present in the antifouling device 1.

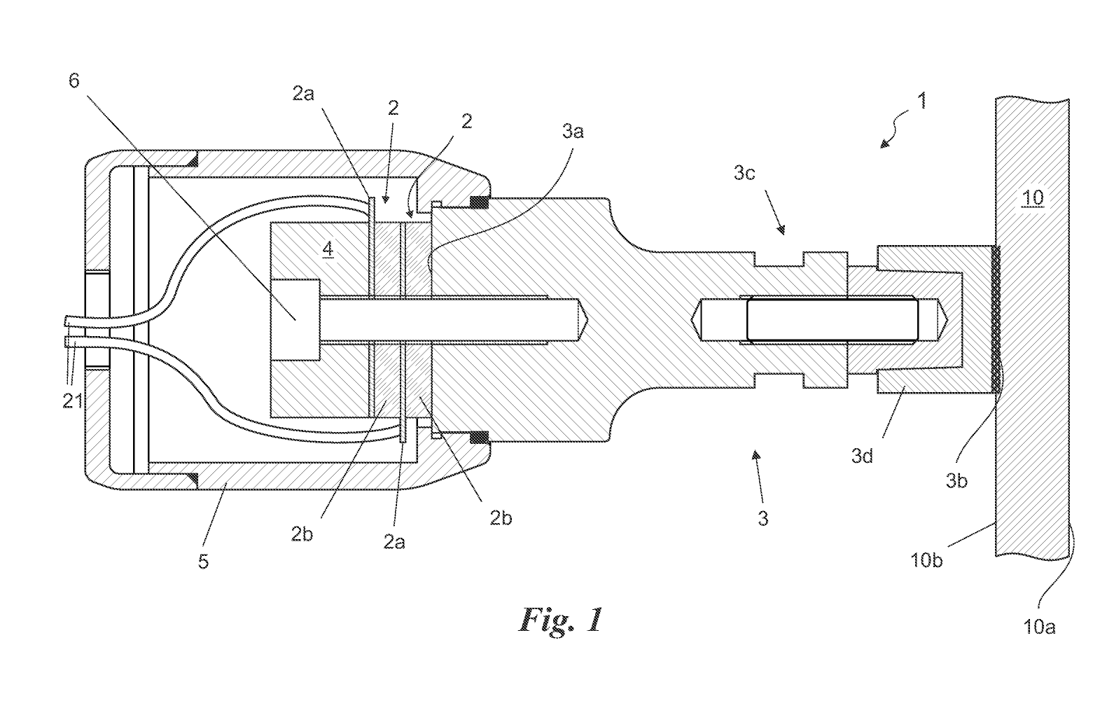

The clamping means 6 can consist of a screw adapted to be fitted into suitable through holes formed in block 4 and bodies 2b and 2a. In particular, for enabling both correct mutual positioning between block 4, units 2 and diffuser 3 and mutual clamping between these elements, said elements, as shown in FIG. 1, have a central through hole passed through by the clamping means 6 and the axis of which is substantially coincident with the axis of the piezoelectric bodies 2a.

In detail, the clamping means 6 is fitted in a motion-admitting manner into bodies 2b, 2a while engagement of same takes place on block 4 by means of the screw head, of bigger sizes than the sizes of the hole formed in block 4, and on diffuser 3 by means of the threaded coupling with the threaded blind hole formed in the diffuser itself.

Block 4 has such a shape as to enable correct channelling or routing of the mechanical vibrations produced by the piezoelectric units 2 towards diffuser 3. In particular, block 4 is of cylindrical shape having a diameter substantially equivalent to the diameter of the piezoelectric bodies 2a and height substantially included between 4 mm and 10 mm.

Diffuser 3 substantially has an axially symmetric structure relative to a main extension axis coincident with the axis of the piezoelectric bodies 2a, and has an upper face 3a in contact with one of said piezoelectric units 2 and a preferably circular lower face 3b, opposite to the upper face 3a, adapted to be brought into contact with duct 10.

Diffuser 3 advantageously has a body of tapering section and more particularly it has a lower face 3b of smaller extension than the upper face 3a.

In particular, the ratio between the extension of the upper face 3a and that of the lower face 3b is substantially included between 1.5 and 7, preferably substantially included between 2 and 5, and more preferably between 3 and 3.5.

Diffuser 3 comprises two distinct elements that can be mutually fastened through a connection preferably of the releasable type, such a friction fit or a threaded coupling. In particular, it comprises an upper element 3c defining the upper face 3a and rigidly secured to the piezoelectric unit 2 by said clamping means 6 and a lower element 3d defining the lower face 3b and adapted to be rigidly secured to the duct and to said upper element 3c.

The upper element 3c as shown in FIG. 1 can consist of two distinct pieces, not shown in the figure, which can be mutually engaged through threaded coupling or, as shown in said figure, by means of a threaded pin suitable for engagement with both pieces.

The lower element 3d can be connected to the upper element 3c in a releasable manner and preferably by threaded coupling.

At the same time, the lower element 3d is secured to duct 10 at the outer surface 10d of said duct through screws, welding or other similar constraining means. Preferably, the lower element 3d is connected to the outer surface 10b of duct 10 in an unreleasable manner and, more preferably, by welding, so as to make the outer surface 10b of duct 10 and lower surface 3b almost integral with each other, and therefore make the lower element 3c and duct 10 substantially appear as of one piece construction.

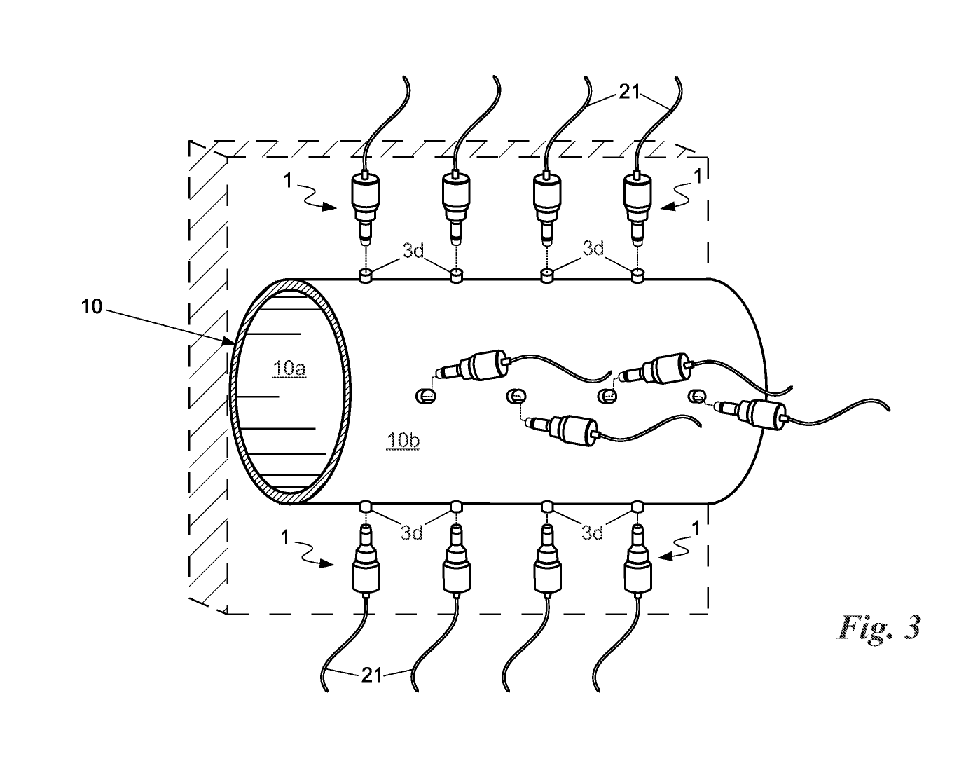

In some cases, as shown in FIG. 3, particular ducts 10 can be provided which comprise lower elements 3d and in particular elements suitably formed on the ducts themselves. Alternatively, in a duct 10 at the outer surface 10b thereof, one or more threaded holes can be obtained for direct engagement with the upper element 3c.

Operation of an antifouling device for ducts described above in terms of structure is the following.

Firs, a plurality of lower elements 3d are disposed on duct 10, on the outer surface 10b thereof. In detail, the lower elements 3d are uniformly distributed along the outer surface 10b and, more specifically, are fastened along the outer surface 10b suitably spaced apart from each other so as to obtain uniform cleaning over the whole inner surface 10a of duct 10.

When all lower elements 3d have been positioned, the antifouling devices 1 are secured to duct 10 by engagement of the lower element 3c of each device 1 with one of the lower elements 3d present on duct 10 and, at the same time, they are connected to generator 20 through the electric connections 21.

At this point, through the control members 22, generator 20 sends the electrical signal adapted to create cavitation in at least part of the fluid, to devices 1 and in particular to the piezoelectric units 2. In detail, generator 20 sends each antifouling device 1 an electrical signal adapted to put each antifouling device 1 in resonance, said device being therefore characterised by a frequency substantially equal to 22 kHz.

Units 2, and more specifically, the piezoelectric bodies 2a, stimulated by such a signal, emit a mechanical vibration at a frequency substantially equal to that of the electrical signal and therefore substantially equal to 22 kHz. This mechanical vibration, through the upper face 3a reaches diffuser 3 that, in turn, transmits it to duct 10 through almost the whole of the lower face 3b, and then to the fluid contained in said duct.

Once the mechanical vibrations have reached the fluid, they cause cavitation of the fluid. In particular, these vibrations at least in the fluid portion close to the inner surface 10a corresponding to the lower element 3d cause sudden pressure lowering, which in turn gives rise to evaporation of the fluid and therefore formation of bubbles.

As soon as these vapour bubbles come into contact with the inner surface 10a, they implode releasing high energy that is transmitted to the inner surface 10a causing removal of a thin layer of material and in particular removal of both vegetable residues and non-vegetable residues present on the inner surface 10a itself.

The mechanical vibrations not only cause the cavitation phenomenon but also give rise to shaking of duct 10 bringing about further separation of residues from the inner surface 10c of duct 10.

The invention comprises a new process for removal of vegetable deposit formations from a duct 10. In particular, the process enables vegetable and non-vegetable deposit formations to be removed from a duct of a seawater circuit.

In this process, as it comes out from the above described operation of the antifouling device 1, duct 10 is provided to be cleaned through a cavitation process created by vibrations having frequency substantially equal to 22 kHz and produced by the antifouling device 1.

This stimulation produced by the antifouling device further enables vibration of duct 10 to be produced, so as to obtain removal of deposits from the inner surface 10a not only by cavitation but also by shaking of said duct.

The invention finally teaches a new use of an antifouling device 1 as above described for removal through cavitation of vegetable residues from a duct of a seawater circuit of a ship, a platform or any other water-craft. In particular, the invention teaches a new use of an antifouling device 1 for removal through cavitation and shaking both of vegetable and non vegetable residues.

The invention enables important advantages to be achieved.

In fact, the antifouling device 1 and, in particular, the cleaning apparatus 100 are particularly simple, of inexpensive manufacture and characterised by reduced bulkiness.

Another advantage is represented by the fact that device 1 and apparatus 100 do not use chlorine or other polluting substances so that polluting substances are not dispersed in the sea.

A further important objective reached by the present antifouling device 1 is represented by the high degree of cleaning that can be obtained by said device. In fact, device 1, due to the particular frequency of the vibrations produced, enables cavitation of the fluid to be obtained close to the material and therefore this phenomenon can be utilised for removing almost the whole of the fouling and therefore of the deposit formations present on ducts 10, from the inner surface 10a.

Another advantage resides in that said removal of the surface layer by cavitation enables removal not only of biofouling but also of non-vegetable residues, i.e. scales usually formed on ducts of the seawater circuits.

Moreover, said high degree of cleaning is ensured by the fact that vibration of the device is caused at frequencies substantially coincident with the resonance frequencies and therefore the produced vibrations are of high amplitude so that deposits can also be removed by shaking of duct 10. Said possibility of obtaining cavitation of the fluid present in duct 10 is ensured by the fact that, due to the particular shape of diffuser 3 and in particular the greater extension of the upper face 3a relative to the lower face 3b, vibrations are concentrated on a restricted portion.

In particular, due to such a shape of diffuser 3, the vibrations pass through an object of tapering section in the advancing direction of the vibrations themselves and therefore concentration of same occurs on the lower face 3b, so that their exploitation can take place in an optimal manner. In conclusion, the greater extension of the upper face 3a relative to the lower one 3b allows the antifouling device 1 to be more effective so that, as a result, the energy consumption is reduced.

Said high quality of wave transmission and, as a result, high degree of cleaning is further ensured by the fact that the lower element 3d and duct 10 are mutually fastened by welding, so that, unlike that which happens when screws or bolts are for instance used, optimal transmission of the vibrations can be ensured over the whole extension of the lower face 3b.

A further advantage resulting from the absence of screws or bolts resides in that drilling or other similar operations can be avoided, which operations would cause structural weakening of duct 10 and, as a result, would increase the possibilities that it may break. Moreover, welding allows a more reliable constraint to be created as compared with an engagement by means of screws or bolts that, due to vibrations, would be subjected to unscrewing and therefore would cause incorrect fastening of device 1.

1. An antifouling device (1) adapted to be fastened to a duct (10) containing a fluid, and to be connected to a generator apparatus (20) for generation of an alternating electrical signal; said antifouling device (1) comprising at least one piezoelectric unit (2) to convert said alternating electrical signal into mechanical vibrations, and a diffuser (3) to be interposed between said duct (10) and said at least one piezoelectric unit (2) so as to transmit said mechanical vibrations from said piezoelectric unit (2) to said duct (10) to create cavitation of at least part of said fluid.

2. An antifouling device (1) as claimed in claim 1, wherein said diffuser (3) comprises an upper face (3a) in contact with said at least one piezoelectric unit (2) and a lower face (3b) opposite to said upper face (3a) and adapted to come into contact with said duct (10); and wherein said lower face (3b) has a smaller extension than said upper face (3a).

3. An antifouling device (1) as claimed in claim 2, wherein the ratio of the extension of said upper face (3a) to the extension of said lower face (3b) is substantially between 3 and 3.5.

4. An antifouling device (1) as claimed in claim 1, wherein said diffuser (3) comprises an upper element (3c) defining said upper face (3a) and rigidly connected to said piezoelectric unit (2) and a lower element (3d) defining said lower face (3b) and adapted to be rigidly secured to said duct; and wherein said upper element (3c) and lower element (3d) are mutually connected in a releasable manner.

5. An antifouling device (1) as claimed in claim 4, wherein said lower element (3d) is rigidly connected to said duct (10) by welding.

6. An antifouling device (1) as claimed in claim 4, wherein said at least one piezoelectric unit (2) comprises a piezoelectric body (2a) to convert said alternating electrical signal into said mechanical vibrations, and a conductive body (2b) adapted to enable said alternating electrical signal to pass from said generator (20) to said piezoelectric body (2a).

7. An antifouling device (1) as claimed in claim 6, wherein said piezoelectric body (2b) has a disc-shaped form with an outer diameter substantially between 20 mm and 50 mm and thickness substantially between 2 mm and 15 mm.

8. An antifouling device (1) as claimed in claim 7, wherein said diameter and thickness of said piezoelectric body (2a) are substantially equal to 38 mm and 5 mm, respectively.

9. A cleaning apparatus for ducts including at least one antifouling device (1), as claimed in claim 1.

10. A cleaning apparatus (100) for ducts as claimed in claim 9, comprising said generator (20) adapted to send said alternating electrical signal to said at least one antifouling device (1), so that said antifouling device produces said mechanical vibrations at frequencies substantially between 10 kHz and 50 kHz.

11. A cleaning apparatus (100) as claimed in claim 10, wherein said generator (20) sends said alternating electrical signal to said at least one antifouling device (1), so that said antifouling device (1) produces said mechanical vibrations at frequencies substantially equal to 22 kHz.

12. A process for removal of vegetable deposit formations from a duct (10) comprising a stimulation step in which said duct is stimulated through vibrations adapted to generate cavitation of the fluid contained in said duct.

13. A process for removal of vegetable deposit formations as claimed in claim 12, wherein in said stimulation step said vibrations cause removal of said deposits through shaking of said duct (10).
